(19) United States
(12) Patent Application Publication
(10) Pub. No.: US 2021/0233001 A1
(43) Pub. Date: Jul. 29, 2021

(54) PROJECT SIMULATION, ANALYSIS AND PERFORMANCE METRICS

(71) Applicant: Western New England University, Springfield, MA (US)

(72) Inventors: Christian M. Salmon, Northampton, MA (US); David Greenslade, Southington, CT (US)

(21) Appl. No.: 17/161,859

(22) Filed: Jan. 29, 2021

Related U.S. Application Data
(60) Provisional application No. 62/967,287, filed on Jan. 29, 2020.

(51) Int. Cl. G06Q 10/06

(52) U.S. Cl. CPC G06Q 10/06313; G06Q 10/067

(57) ABSTRACT

A method of simulation and management of a project includes defining a first project data set, including historical project planning data and defining a second project data set, including specific data regarding the project. A baseline project schedule is defined utilizing the first project data set and the second project data set. The baseline project schedule includes a plurality of project tasks. A plurality of simulations of the project are run utilizing the baseline project schedule and task-specific duration variations, and a necessary project buffer is determined based on analysis of output data of the simulations.

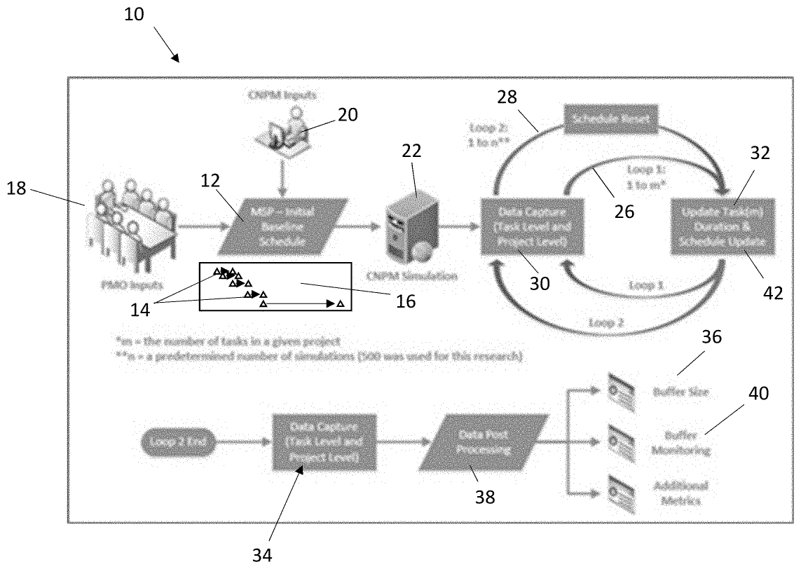

### CROSS-REFERENCE TO RELATED APPLICATIONS

This application claims the benefit of U.S. Provisional Application No. 62/967,287 filed Jan. 29, 2020, the disclosure of which is incorporated herein by reference in its entirety.

### BACKGROUND

Exemplary embodiments disclosed herein relate to the art of project management.

In 1911, Fredrick Taylor published “The Principle of Scientific Management” which was followed by the creation of the Gantt Chart by Henry Gantt in 1917. The Critical Path technique was later developed by Morgan R. Walker of DuPont and James E. Kelley of Remington Rand in 1957 and has been regarded as the most used project management methodology. Several project management organizations were formed in the subsequent years and that led to the development of several other project management methodologies, such as Scrum, Earned Value Management, and Agile, for example.

In 1997, the next generation of project management principles were developed by Eliyahu M. Goldratt, termed the Critical Chain Project Management (CCPM) methodology. Since the launch of CCPM, which has been widely accepted and applied by project managers and organizations across the world, future developments have been far and few in between.

Despite the initial success of CCPM, a review was published focusing on project risk management techniques for complex projects. The report concluded that there is no consensus regarding which techniques work best to provide accurate estimates of time and cost risks because most projects still see overruns in both areas, and that continued research and development of best practices is required in order to reduce the likelihood of over/under estimates of project costs and time estimates, and ultimately project success or failure.

Concurrently, organizations such as Project Management Institute (PMI), American National Standards Institute (ANSI), and International Organization for Standardization (ISO) have developed general frameworks to increase the likelihood of successful projects. However, despite these efforts, complex projects are still failing at high rates.

Furthermore, the state of the art project management method (CCPM), utilizes only general rules of thumb for sizing schedule buffers that are intended to protect the project from time delays that occur during projects. In addition, the state of the art mechanism for monitoring the health of a project through analysis of these buffers uses overly simplistic linear assumptions to assess buffer consumption expectation as a function of time across the life of the project.

### BRIEF DESCRIPTION

In one embodiment, a method of simulation and management of a project includes defining a first project data set, including historical project planning data and defining a second project data set, including specific data regarding the project. A baseline project schedule is defined utilizing the first project data set and the second project data set. The baseline project schedule includes a plurality of project tasks. A plurality of simulations of the project are run utilizing the baseline project schedule and task-specific duration variations, and a necessary project buffer is determined based on analysis of output data of the simulations.

Additionally or alternatively, in this or other embodiments progress of the project is monitored, thereby adding actual task progress data to the baseline project schedule, the necessary project buffer is updated based on the actual task progress.

Additionally or alternatively, in this or other embodiments the simulation includes executing a first loop of the simulation for each task of the plurality of tasks, and executing a second loop of the simulation for a predetermined number of iterations of the project schedule.

Additionally or alternatively, in this or other embodiments each of the first loop and the second loop includes a data capture portion, and an update portion, at which task durations and the schedule are updated based on input from the data capture portion.

Additionally or alternatively, in this or other embodiments the number of iterations is in a range of 500 to 1000 iterations.

In another embodiment, a method of simulation and management of a project includes defining a baseline project schedule, the baseline project schedule including a plurality of project tasks, and running a plurality of simulations of the project utilizing the baseline project schedule and task-specific duration variations.

A necessary project buffer is determined based on analysis of output data of the simulations, and progress of the project is monitored, thereby adding actual task progress data to the baseline project schedule. The necessary project buffer is updated based on the actual task progress.

Additionally or alternatively, in this or other embodiments a first project data set, including historical project planning data is defined, and a second project data set, including specific data regarding the project is defined. The baseline project schedule is defined using the first project data set and the second project data set.

Additionally or alternatively, in this or other embodiments the simulation includes executing a first loop of the simulation for each task of the plurality of tasks, and executing a second loop of the simulation for a predetermined number of iterations of the project schedule.

Additionally or alternatively, in this or other embodiments each of the first loop and the second loop include a data capture portion and an update portion, at which task durations and the schedule are updated based on input from the data capture portion.

Additionally or alternatively, in this or other embodiments the number of iterations is in a range of 500 to 1000 iterations.

### BRIEF DESCRIPTION OF THE DRAWINGS

The following descriptions should not be considered limiting in any way. With reference to the accompanying drawings, like elements are numbered alike:

The FIGURE is an illustration of a method for project simulation, analysis and performance metric development.

### DETAILED DESCRIPTION

A detailed description of one or more embodiments of the disclosed apparatus and method are presented herein by way of exemplification and not limitation with reference to the FIGURE.

The system and method of present disclosure seeks to provide a solution to the shortcomings discussed above by providing a process for project simulation, analysis and performance metric development that each utilize project-specific data and characteristics so a user can manage a project more efficiently and utilize real-time performance metrics that increase the project manager's capacity to anticipate problems and mitigate project challenges.

Referring now to the FIGURE, illustrated is a schematic illustration of an embodiment of a method 10 of project simulation, analysis and performance metric development project.

The method 10 utilizes two types of data as inputs to develop an initial baseline project schedule 12, the schedule 12 including a plurality of tasks 14 laid out along a project timeline 16. A first data type, Project Management Office (PMO) data 18, includes pre-existing or historical data such as task identifiers, dependencies between tasks, resource dependencies between tasks or the like. The PMO data 18 is typically already established and formalized through standard project team development methods. A second data type, Critical Network Project Management (CNPM) input data 20, includes new input metrics such as task-specific duration distributions or duration distributions (with ranges based on percentages) for groups of tasks. The CNPM input data 20, together with the PMO data 18, is utilized to integrate underlying stochastic, random, variations into the project planning process of method 10.

The PMO data 18 and the CNPM data 20 are utilized to define the baseline project schedule 12, and a CNPM simulation 22 is performed. The CNPM simulation 22 generates a plurality of modified versions of the project schedule 12 in order to identify conflicting objectives between schedule objectives and resource constraints, and also performs probabilistic analysis of the modified versions. More specifically, the CNPM simulation 22 is run for each task 14 of the plurality of tasks 14 in a first loop 26, and for a predetermined number of simulations of the project schedule 12 in a second loop 28. In some embodiments of the method 10, the number of simulations is between, for example, 500 and 1000 simulations. Each loop of the first loop 26 and the second loop 28 includes a data capture portion 30 and an update portion 32, at which task 14 durations and schedule 12 are updated based on input from the data capture portion 30. The update process occurs every time after a task duration has been redefined from the distribution. When the task duration changes, that task and all tasks downstream can often be re-optimized to create the shortest schedule possible. Task 14 durations and schedule 12 are reset after the schedule 12 and tasks 14 are simulated one complete time. After one full simulation of each task 14 in the project, data capture occurs. Then the schedule 12 is “reset” to the baseline so the schedule 12 can be simulated again. After many simulation iterations a statistical analysis can be run on the data capture relative to each simulation and the baseline schedule 12.

Completion of the CNPM simulation 22 results in output data 34 being produced. The output data 34 is processed at block 38, and once processed may be utilized to determine, for example, a relevant project buffer time 36 and buffer monitor 40 in, for example, days, weeks, or months, which will mitigate the likelihood of unacceptable project delay without overburdening the project schedule 12 with excess safety time. The data 34 is incorporated into the schedule 12 and provides a simulated schedule 42 based on the output of the simulation. This simulated schedule 42 may be compared to the baseline schedule 12 and/or other simulated schedules 42, which are the results of other simulation iterations.

The entire simulation process can be run over and over throughout the life of the project. The baseline schedule 12 will remain the same unless updates are made due to scheduling changes or overall project changes. By running the simulation each week, month, etc. over the life of the project, the users get new and more up to date information if the base line schedule 12 changed significantly. If the baseline schedule 12 is relatively the same, the results of each simulation iteration should converge with previous iterations.

This provides a user with a project-specific monitoring module 40 that captures the dominant proportion of asymmetrically induced risk, based on the inherent structure of the project schedule 12.

The output data 34 is also utilized to monitor additional metrics from project sensitivity to task-specific risks through which the user can assess anticipatory risks that might manifest and negatively impact the project. Using the actual task progress and the post processed data 38, the project buffer may be continuously updated along with a risk adjusted project buffer consumption if unanticipated shocks to the project occur.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of simulation and management of a project, comprising:
defining a first project data set, including historical project planning data;
defining a second project data set, including specific data regarding the project;
defining a baseline project schedule utilizing the first project data set and the second project data set, the baseline project schedule including a plurality of project tasks;
running a plurality of simulations of the project utilizing the baseline project schedule and task-specific duration variations; and
determining a necessary project buffer based on analysis of output data of the simulations.

2. The method of claim 1, further comprising:
monitoring progress of the project, thereby adding actual task progress data to the baseline project schedule; and
updating the necessary project buffer based on the actual task progress.

3. The method of claim 1, wherein the simulation includes:
executing a first loop of the simulation for each task of the plurality of tasks; and
executing a second loop of the simulation for a predetermined number of iterations of the project schedule.

4. The method of claim 3, wherein each of the first loop and the second loop includes:
a data capture portion; and
an update portion, at which task durations and the schedule are updated based on input from the data capture portion.

5. The method of claim 3, wherein the number of iterations is in a range of 500 to 1000 iterations.

6. A method of simulation and management of a project, comprising:
defining a baseline project schedule, the baseline project schedule including a plurality of project tasks;
running a plurality of simulations of the project utilizing the baseline project schedule and task-specific duration variations;
determining a necessary project buffer based on analysis of output data of the simulations;
monitoring progress of the project, thereby adding actual task progress data to the baseline project schedule; and
updating the necessary project buffer based on the actual task progress.

7. The method of claim 6, further comprising:
defining a first project data set, including historical project planning data; and
defining a second project data set, including specific data regarding the project;
wherein the baseline project schedule is defined using the first project data set and the second project data set.

8. The method of claim 6, wherein the simulation includes:
executing a first loop of the simulation for each task of the plurality of tasks; and
executing a second loop of the simulation for a predetermined number of iterations of the project schedule.

9. The method of claim 8, wherein each of the first loop and the second loop includes:
a data capture portion; and
an update portion, at which task durations and the schedule are updated based on input from the data capture portion.

10. The method of claim 8, wherein the number of iterations is in a range of 500 to 1000 iterations.
